(19) United States
(12) Patent Application Publication
(10) Pub. No.: US 2010/0033406 A1
(43) Pub. Date: Feb. 11, 2010

(54) PLASMA DISPLAY AND DRIVING APPARATUS THEREOF

(76) Inventor: Jin-Ho Yang, Suwon-si (KR)

Correspondence Address: CHRISTIE, PARKER & HALE, LLP, PO BOX 7068, PASADENA, CA, 91109-7068, US

(21) Appl. No.: 12/331,246

(22) Filed: Dec. 9, 2008

Related U.S. Application Data
(60) Provisional application No. 61/087,936, filed on Aug. 11, 2008.

(51) Int. Cl. G09G 3/28

(52) U.S. Cl. 345/60

(57) ABSTRACT

A plasma display with an improved energy recovery circuit. The plasma display includes a display electrode coupled to an energy recovery circuit. The energy recovery circuit includes an energy recovery capacitor and a circuit unit that is configured to form a first path between the energy recovery capacitor and the display electrode to change a voltage at the display electrode in a sustain period. The energy recovery capacitor includes a plurality of capacitors configured to be charged concurrently, and the circuit unit is configured to selectively substantially prevent a current from flowing between two capacitors of the plurality of capacitors via a second path.

### CROSS REFERENCE TO RELATED APPLICATION

This application claims priority to and the benefit of U.S. Provisional Application No. 61/087,936, filed on Aug. 11, 2008, the entire content of which is incorporated herein by reference.

### BACKGROUND OF THE INVENTION

1. Field of the Invention

The present invention relates to a plasma display and a driving apparatus thereof.

2. Description of Related Art

A plasma display includes a display panel having a plurality of display electrodes and a plurality of cells corresponding to the display electrodes. To emit light, sustain pulses having a high level voltage and a low level voltage are alternately applied to the display electrodes in order to perform sustain discharges in the cells. Hereinafter, the cells will be referred to as light emitting cells. Since a capacitive component (hereinafter referred to as a panel capacitor) exists between two display electrodes using which the sustain discharges are generated, reactive power is generated when the high level voltage and the low level voltage are alternately applied to the display electrodes. A typical plasma display includes an energy recovery circuit for capturing and reusing the reactive power.

The energy recovery circuit generates a resonance between an inductor, which is electrically coupled between a panel capacitor and an energy recovery capacitor, and the panel capacitor, recovers a resonant current discharged from the panel capacitor to an energy recovery capacitor, and supplies the recovered resonant current from the energy recovery capacitor to charge the panel capacitor. In order to increase the capacitance of the energy recovery capacitor, a plurality of capacitors, each having the same capacitance, may be coupled in parallel. However, the plurality of capacitors coupled in parallel may deviate from each other in capacitance or parasitic inductance components.

When a deviation exists between the plurality of capacitors, for example between the first capacitor and the second capacitor, a resonance cycle between the first capacitor and the inductor is different from a resonance cycle between the second capacitor and the inductor so that the amount of current flowing to the first capacitor and the amount of current flowing to the second capacitor may differ from one another at the finishing point of the resonance cycle. Then, the resonance is generated again through a closed loop that includes the first capacitor, the parasitic inductance component coupled to the first capacitor, the second capacitor, and the parasitic inductance component coupled to the second capacitor so that a resonance current may flow in the closed loop. Even when the first and second capacitors have the same capacitance, an inductance of the parasitic inductance component coupled to the first capacitor may differ from that of the parasitic inductance component coupled to the second capacitor. When the resonance cycle between the first capacitor and the inductor and the resonance cycle between the second capacitor and the inductor become different from each other due to the deviation of the parasitic inductance components, a resonance may occur in the closed loop.

While the resonance is being generated, the resonance cycle is proportional to a square root of the product of the capacitance of the capacitor and the inductance of the inductor in the resonance path. However, the capacitance of each of the first and second capacitors is suitably set to be larger than that of the panel capacitor, and the inductance of the inductor is suitably set to be larger than that of the parasitic inductance component of the energy recovery circuit. Therefore, a resonance cycle performed with the first and second capacitors and the parasitic inductance components in the closed loop may be similar to a resonance cycle performed with the panel capacitor and the inductor.

Furthermore, the resonance current in the closed loop may reach a maximum value during a period in which the high level voltage or the low level voltage is applied to the display electrodes. Accordingly, a large resonance current is repeatedly supplied to the first and second capacitors while the period is repeated so that temperatures of the first and second capacitors increase, thereby causing overheating of the energy recovery circuit or degradation of the first and second capacitors.

### SUMMARY OF THE INVENTION

Embodiments of the present invention provide a plasma display and a driving apparatus thereof for reducing resonances between a plurality of capacitors that form an energy recovery circuit.

According to an embodiment of the present invention, a plasma display includes a display electrode and an energy recovery circuit. The energy recovery circuit includes an energy recovery capacitor and a circuit unit that is configured to form a first path between the energy recovery capacitor and the display electrode to change a voltage at the display electrode in a sustain period. The energy recovery capacitor includes a plurality of capacitors configured to be charged concurrently, and the circuit unit is configured to selectively substantially prevent a current from flowing between two capacitors of the plurality of capacitors via a second path.

The circuit unit may include: a plurality of switches, each of the plurality of switches having a first terminal coupled to a corresponding one of the plurality of capacitors and a second terminal; and an inductive unit coupled between the display electrode and the plurality of switches. The second path may include the plurality of switches.

The inductive unit may include a plurality of inductors, and each of the plurality of inductors has a first terminal coupled to the display electrode and a second terminal coupled to the second terminal of a corresponding one of the plurality of switches. The plurality of switches may be configured to be turned off for substantially preventing the current.

The circuit unit may include: a plurality of switches, each of the plurality of switches having a first terminal coupled to the display electrode and a second terminal; and an inductive unit coupled between the second terminals of the plurality of switches and the plurality of capacitors. The second path may include the inductive unit and the plurality of switches.

The circuit unit may further include a plurality of diodes coupled between the inductive unit and the plurality of switches. The inductive unit may include a plurality of inductors each coupled between a corresponding one of the plurality of capacitors and a corresponding one of the plurality of diodes. The second path may further include the plurality of diodes. The plurality of switches may be configured to be turned off for substantially preventing the current.

The circuit unit may include: a plurality of diodes each having one terminal coupled to a corresponding one of the plurality of capacitors; a switching unit having one terminal coupled to another terminal of each of the plurality of diodes; and an inductive unit coupled between the display electrode and another terminal of the switching unit. The second path may include the plurality of diodes.

The circuit unit may include: a plurality of diodes each having one terminal coupled to a corresponding one of the plurality of capacitors; a plurality of switches each having one terminal coupled to another terminal of at least one diode of the plurality of diodes; and an inductive unit coupled between the display electrode and the plurality of switches. The second path may include the plurality of diodes and the plurality of switches.

The circuit unit may include: a plurality of diodes each having one terminal coupled to a corresponding one of the plurality of capacitors; a plurality of switches each having one terminal coupled to the display electrode; and an inductive unit coupled between another terminal of each of the plurality of diodes and another terminal of each of the plurality of switches. The second path may include the inductive unit, the plurality of diodes and the plurality of switches.

According to an embodiment of the present invention, a plasma display includes: a display electrode; a plurality of capacitors configured to be charged concurrently, each of the capacitors having a first terminal coupled to a ground terminal and a second terminal; first switches, each of the first switches having a first terminal coupled to the second terminal of a corresponding one of the capacitors and a second terminal; second switches, each of the second switches having a first terminal coupled to the second terminal of a corresponding one of the capacitors and a second terminal; and an inductive unit coupled between the display electrode and the second terminals of the first switches and the second switches. The first switches are configured to form a first path between the capacitors and the display electrode to increase a voltage at the display electrode, and the second switches are configured to form a second path between the capacitors and the display electrode to decrease the voltage at the display electrode.

The first switches and the second switches may be configured to selectively substantially prevent a current from flowing between two capacitors of the capacitors via a third path.

The inductive unit may include a first inductor having a first terminal coupled to the display electrode and a second terminal coupled to the second terminal of at least one of the first switches; and a second inductor have a first terminal coupled to the display electrode and a second terminal coupled to the second terminal of at least one of the second switches. The first switches and the second switches may be configured to be turned off for substantially preventing the current.

According to an embodiment of the present invention, a plasma display includes: a display electrode; a plurality of capacitors configured to be charged concurrently, each of the capacitors having a first terminal coupled to a ground terminal and a second terminal; a first switching unit having a terminal coupled to the display electrode; a second switching unit having a terminal coupled to the display electrode; first inductors coupled between the plurality of capacitors and the first switching unit, each of the first inductors having a terminal coupled to the second terminal of a corresponding one of the plurality of capacitors; and second inductors coupled between the plurality of capacitors and the second switching unit, each of the second inductors having a terminal coupled to the second terminal of a corresponding one of the plurality of capacitors.

The first switching unit is configured to form a first path between the capacitors and the display electrode to increase a voltage at the display electrode. The second switching unit is configured to form a second path between the capacitors and the display electrode to decrease the voltage at the display electrode. The first switching unit and the second switching unit are configured to selectively substantially prevent a current from flowing between two capacitors of the capacitors via a third path.

The plasma display may further include first diodes and second diodes. Each of the first diodes may be coupled between a corresponding one of the first inductors and the first switching unit, and each of the second diodes may be coupled between a corresponding one of the second inductors and the second switching unit. The third path may further include the first diodes or the second diodes. The first switching unit and the second switching unit may be configured to be turned off for substantially preventing the current.

According to an embodiment of the present invention, a plasma display includes: a display electrode; a plurality of capacitors, each of the capacitors having a first terminal coupled to a ground terminal and a second terminal; a plurality of first diodes each having a first terminal coupled to the second terminal of a corresponding one of the plurality of capacitors and a second terminal; a plurality of second diodes each having a first terminal coupled to the second terminal of a corresponding one of the plurality of capacitors and a second terminal; a first switching unit coupled between the second terminals of the plurality of first diodes and the display electrode; and a second switching unit coupled between the second terminals of the plurality of second diodes and the display electrode.

The first switching unit is configured to form a first path between the capacitors and the display electrode to increase a voltage at the display electrode, and the second switching unit is configured to form a second path between the capacitors and the display electrode to decrease the voltage at the display electrode.

The first switching unit may include a plurality of first switches, each of the plurality of first switches having a terminal coupled to the second terminal of a corresponding one of the plurality of first diodes. The second switching unit may include a plurality of second switches, each of the plurality of second switches having a terminal coupled to the second terminal of a corresponding one of the plurality of second diodes.

According to an embodiment of the present invention, a plasma display includes: a display electrode; and an energy recovery circuit including an energy recovery capacitor and a circuit unit, the circuit unit configured to form a first path between the energy recovery capacitor and the display electrode to change a voltage at the display electrode in a sustain period. The energy recovery capacitor includes a plurality of capacitors configured to be charged concurrently, and the circuit unit is configured to selectively substantially prevent charge sharing between two capacitors of the plurality of capacitors while the circuit unit interrupts the first path.

### BRIEF DESCRIPTION OF THE DRAWINGS

FIG. 1 is a schematic block diagram of a plasma display according to an exemplary embodiment of the present invention.

FIG. 2 and FIG. 3 are drawings respectively showing driving waveforms in a sustain period of a plasma display according to an exemplary embodiment of the present invention.

FIG. 4 is a schematic circuit diagram of a sustain discharge circuit according to an exemplary embodiment of the present invention.

FIG. 5 is a timing diagram showing signal timing of a sustain discharge circuit according to an exemplary embodiment of the present invention.

FIGS. 6, 7, 8, and 9 are schematic circuit diagrams respectively showing a current path of the sustain discharge circuit in each period shown in FIG. 5.

FIGS. 10, 11, 12, 13, 14, 15, 16, 17, 18, 19, 20, 21 and 22 are schematic circuit diagrams respectively showing circuit diagrams of sustain discharge circuits according to other exemplary embodiments of the present invention.

### DETAILED DESCRIPTION OF EXEMPLARY EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

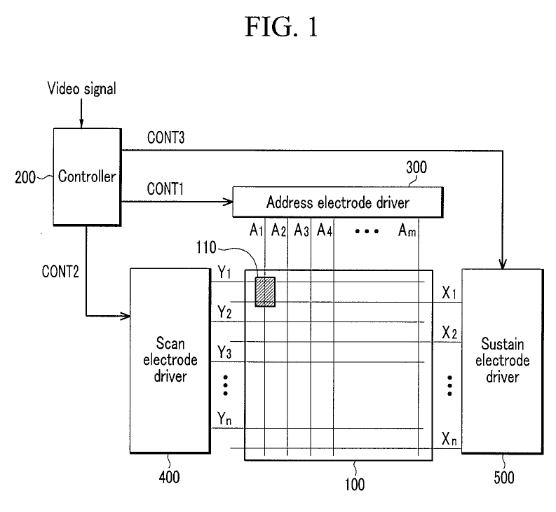

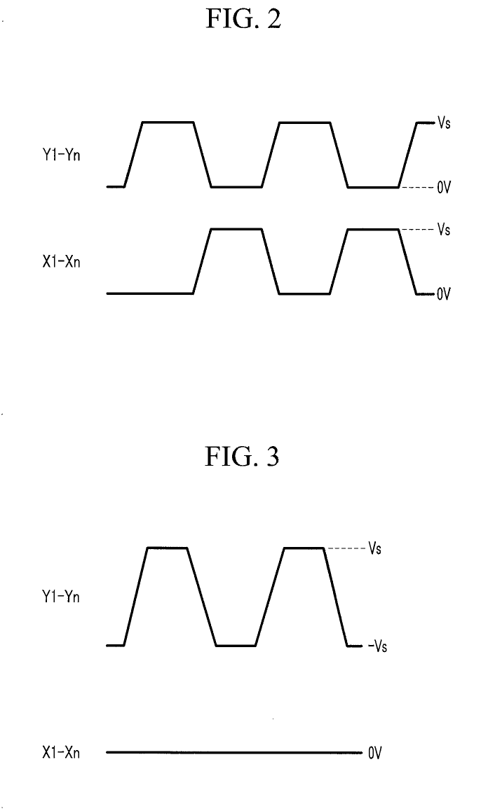

FIG. 1 is a schematic block diagram of a plasma display according to an exemplary embodiment of the present invention, and FIG. 2 and FIG. 3 respectively show driving waveforms in a sustain period of a plasma display according to an exemplary embodiment of the present invention.

Referring to FIG. 1, a plasma display according to an exemplary embodiment of the present invention includes a plasma display panel 100, a controller 200, an address electrode driver 300, a scan electrode driver 400, and a sustain electrode driver 500.

The plasma display panel 100 includes a plurality of display electrodes Y1 to Yn and X1 to Xn, a plurality of address electrodes A1 to Am (hereinafter referred to as “A electrodes”), and a plurality of discharge cells 110.

The plurality of display electrodes Y1 to Yn and X1 to Xn include a plurality of scan electrodes Y1 to Yn (hereinafter referred to as “Y electrodes”) and a plurality of sustain electrodes X1 to Xn (hereinafter referred to as “X electrodes”). The Y electrodes Y1 to Yn and the X electrodes X1 to Xn extend in a row direction and are substantially parallel to each other, and the A electrodes A1 to Am extend in a column direction and are substantially parallel to each other. Each of the Y electrodes Y1 to Yn may correspond to one of the X electrodes X1 to Xn, or one of the Y electrodes Y1 to Yn may correspond to two of the X electrodes X1 to Xn. Here, the discharge cells 110 are formed in the spaces defined by the crossings between the A electrodes A1 to Am, the Y electrodes Y1 to Yn, and the X electrodes X1 to Xn.

While the above-described plasma display panel 100 illustrates an exemplary embodiment of the present invention, the plasma display panel 100 may have other structures to which driving waveforms that will be described below can be applied.

The controller 200 receives a video signal and an input control signal for controlling the display of the video signal. The video signal includes luminance information of each of the discharge cells 110, and the luminance has a number of gray levels. The input control signal may include a vertical synchronization signal and a horizontal synchronization signal.

The controller 200 divides one picture frame for displaying an image into a plurality of subfields, each of which has a luminance weight and includes an address period and a sustain period. The controller 200 processes the video signal and the input control signal in accordance with the plurality of subfields and generates an A electrode driving control signal CONT1, a Y electrode driving control signal CONT2, and an X electrode driving control signal CONT3. The controller 200 outputs the A electrode driving control signal CONT1 to the address electrode driver 300, the Y electrode driving control signal CONT2 to the scan electrode driver 400, and the X electrode driving control signal CONT3 to the sustain electrode driver 500.

From the video signal that corresponds to each discharge cell, the controller 200 generates subfield data that indicate a light-emitting/non-light emitting state of each discharge cell in the plurality of subfields, and the A electrode driving control signal CONT1 includes the subfield data. The Y electrode driving control signal CONT2 and the X electrode driving control signal CONT3 include a sustain discharge control signal that controls the number of sustain discharge occurrences and/or sustain discharge operations in the sustain period of each subfield. In addition, the Y electrode driving control signal CONT2 further includes a scan control signal that controls a scan operation in the address period of each subfield.

The scan electrode driver 400 sequentially applies a scan voltage to the Y electrodes Y1 to Yn in the address period according to the Y electrode driving control signal CONT2. For identifying light-emitting cells and non-light emitting cells from the plurality of discharge cells coupled to the Y electrodes to which the scan voltage is applied, the address electrode driver 300 applies a voltage to the A electrodes A1 to Am in accordance with the A electrode driving control signal CONT1.

After the light-emitting cells and the non-light emitting cells are identified in the address period, the scan electrode driver 400 and the sustain electrode driver 500 apply a sustain pulse to the Y electrodes Y1 to Yn and the X electrodes X1 to Xn a number of times that corresponds to a luminance weight of each subfield during the sustain period in accordance with the Y electrode driving control signal CONT2 and the X electrode driving control signal CONT3.

Referring to FIG. 2, the sustain pulse has a high level voltage Vs and a low level voltage (e.g., 0V). When the high level voltage Vs is applied to the Y electrodes Y1 to Yn while the low level voltage is applied to the X electrodes X1 to Xn, a sustain discharge occurs in the discharge cell due to a voltage difference between the high level voltage Vs and the low level voltage, and when the low level voltage is applied to the Y electrodes Yl to Yn and the high level voltage Vs is applied to the X electrodes X1 to Xn, the sustain discharge occurs again in the discharge cell due to the voltage difference between the high level voltage Vs and the low level voltage. The above-described processes are repeated such that the sustain discharge occurs a number of times that corresponds to the luminance weight of a subfield.

Referring to FIG. 3, a sustain pulse that has the high level voltage Vs and a low level voltage −Vs may be applied only to the Y electrodes Y1 to Yn while a predetermined voltage (e.g., 0V) is applied to the X electrodes X1 to Xn. Alternatively, the sustain pulse having the high level voltage Vs and the low level voltage −Vs may be applied only to the X electrodes X1 to Xn while the predetermined voltage is applied to the Y electrodes Y1 to Yn. Therefore, the sustain discharge may occur in the discharge cell by setting a voltage difference between the high level voltage Vs and the predetermined voltage (e.g., 0V) and a voltage difference between the low level voltage −Vs and the predetermined voltage (e.g., 0V) to be similar to the voltage difference between the high level voltage Vs and the low level voltage (0V) of FIG. 2.

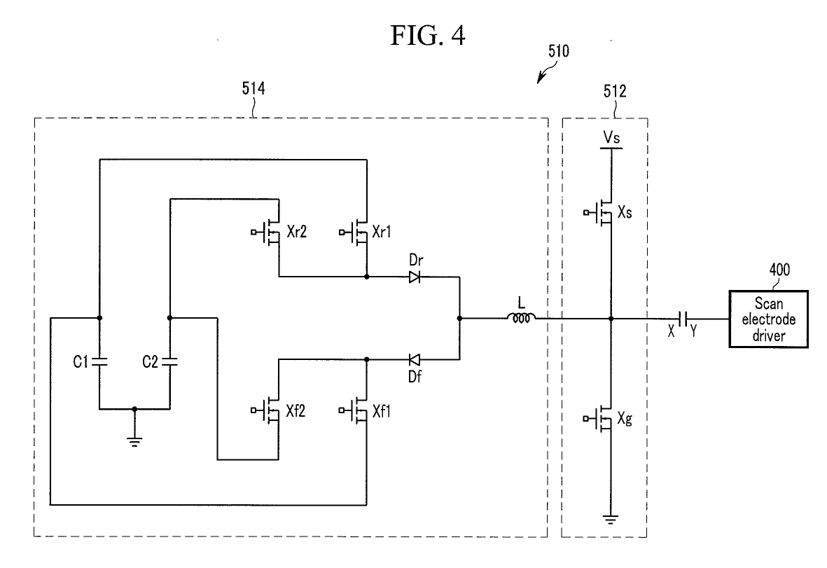

A sustain discharge circuit of the plasma display that generates a driving waveform (i.e., a sustain pulse) in a sustain period will be described with reference to FIG. 4.

FIG. 4 is a schematic circuit diagram of a sustain discharge circuit according to an exemplary embodiment of the present invention.

Referring to FIG. 4, a sustain discharge circuit 510 includes a voltage sustain unit 512 and an energy recovery circuit 514.

The sustain discharge circuit 510 may be part of the sustain electrode driver 500, and may be coupled to all of the plurality of X electrodes X1 to Xn or may be coupled to some of the X electrodes X1 to Xn. Alternatively, the sustain discharge circuit 510 may be part of the scan electrode driver 400, and may be coupled to all or some of the plurality of Y electrodes Y1 to Yn. In FIG. 4, the sustain discharge circuit 510 is shown to be coupled to the X electrodes, and only one of the X electrodes X1 to Xn is shown. In addition, a capacitive component formed by the X electrode and the Y electrode is illustrated as a capacitor (hereinafter referred to as a “panel capacitor”).

The voltage sustain unit 512 includes transistors Xs and Xg, and applies the high level voltage Vs or the low level voltage to the X electrode.

The energy recovery circuit 514 includes transistors Xr1, Xr2, Xf1, Xf2, diodes Dr and Df, an inductor L, and a plurality of capacitors C1 and C2. The energy recovery circuit 514 provides a path for increasing a voltage of the X electrode or a path for decreasing the voltage of the X electrode.

Each of the transistors Xs, Xg, Xr1, Xr2, Xf1, and Xf2 is a switch including a control terminal, an input terminal, and an output terminal. In FIG. 4, the transistors Xs, Xg, Xr1, Xr2, Xf1, and Xf2 are each illustrated as an N-channel field effect transistor (FET), and in this case, the control terminal, the input terminal, and the output terminal respectively correspond to a gate, a drain, and a source. Alternatively, other transistor types or transistors with a different channel from the N-channel FET, for example insulated gate bipolar transistors (IGBTs), may be used as the transistors Xs, Xg, Xr1, Xr2, Xf1, and Xf2.

Each of the transistors Xs, Xg, Xr1, Xr2, Xf1, and Xf2 may include a body diode (not shown), and an anode of the body diode is coupled to a source of a corresponding one of the transistors Xs, Xg, Xr1, Xr2, Xf1, and Xf2. A cathode of the body diode is coupled to a drain of a corresponding one of the transistors Xs, Xg, Xr1, Xr2, Xf1, and Xf2. Each of the transistors Xs, Xg, Xr1, Xr2, Xf1, and Xf2 receives a control signal (not shown) for controlling its operation through the gate, and the control signal is applied by the sustain electrode driver 500 according to the X electrode control signal CONT3.

The drain of the transistor Xs is coupled to a power source that supplies the high level voltage Vs, and the source of the transistor Xs is coupled to the X electrode. The drain of the transistor Xg is coupled to the X electrode, and the source of the transistor Xg is coupled to a power source (e.g., a ground terminal) that supplies the low level voltage.

The plurality of capacitors C1 and C2 form an energy recovery capacitor, and although FIG. 4 illustrates only two capacitors for ease of description, the energy recovery capacitor may be formed by three or more capacitors. One terminal of each of the plurality of capacitors C1 and C2 is coupled to a power source that supplies a predetermined voltage (e.g., a low level voltage or a ground level voltage). In FIG. 4, the plurality of capacitors C1 and C2 may store a voltage between the high level voltage Vs and the low level voltage, for example, a voltage at approximately half the voltage difference between the high level voltage Vs and the low level voltage.

The sources of the transistors Xr1 and Xr2 are coupled to an anode of the diode Dr, the drain of the transistor Xr1 is coupled to the other terminal of the capacitor C1, and the drain of the transistor Xr2 is coupled to the other terminal of the capacitor C2. The drains of the transistors Xf1 and Xf2 are coupled to a cathode of the diode Df, the source of the transistor Xf1 is coupled to the other terminal of the capacitor C1, and the source of the transistor Xf2 is coupled to the other terminal of the capacitor C2. A cathode of the diode Dr and an anode of the diode Df are coupled to one terminal of the inductor L, and the other terminal of the inductor L is coupled to the X electrode.

The transistors Xr1 and Xr2 and the diode Dr form a current path for charging the panel capacitor, that is, for increasing the voltage of the X electrode. The transistors Xf1 and Xf2 and the diode Df form a current path for discharging the panel capacitor, that is, for decreasing the voltage of the X electrode. Each of the diodes Dr and Df blocks a backward current path that can be formed by the body diode of each of the transistors Xr1/Xr2 and Xf1/Xf2. In some embodiments of the present invention, the current path is not formed in a direction from the source to the drain of each of the transistors Xr1/Xr2 and Xf1/Xf2, therefore the diodes Dr and Df may be eliminated.

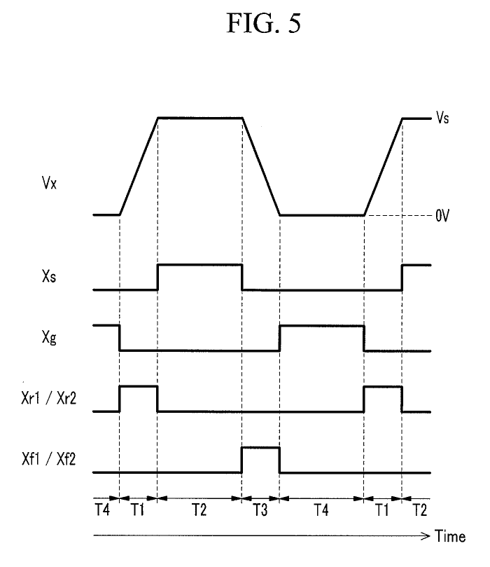

Operation of the sustain discharge circuit 510 will be described with reference to FIG. 5 to FIG. 9.

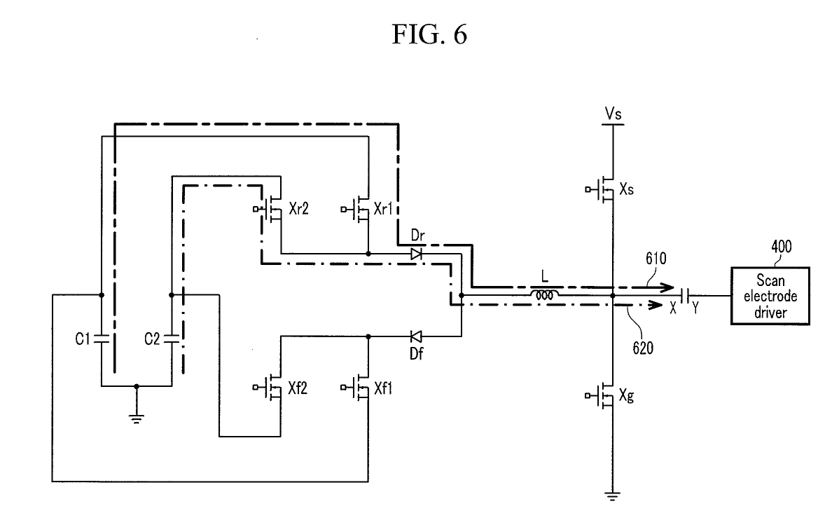

FIG. 5 shows signal timing of the sustain discharge circuit 510 according to an exemplary embodiment of the present invention, and FIG. 6 to FIG. 9 respectively illustrate a current path of the sustain discharge circuit 510 in each time period shown in FIG. 5.

In FIG. 5, a voltage of the control signal applied to the gate of each of the transistors Xs, Xg, Xr1, Xr2, Xf1, and Xf2 is illustrated to indicate a turn-on/turn-off state of each of the transistors Xs, Xg, Xr1, Xr2, Xf1, and Xf2. The transistors Xs, Xg, Xr1, Xr2, Xf1, and Xf2 are turned on when the voltage of the control signal is a high level voltage and turned off when the voltage of the control signal is a low level voltage.

Referring to FIG. 5 and FIG. 6, during a rising period T1, the transistor Xg is turned off, and the transistors Xr1/Xr2 are turned on while the transistors Xs and Xf1/Xf2 are turned off. Accordingly, a resonance is generated between the inductor L and the panel capacitor through a current path 610 that includes the capacitor Cl, the transistor Xr1, the diode Dr, the inductor L, and the X electrode, and a current path 620 that includes the capacitor C2, the transistor Xr2, the diode Dr, the inductor L, and the X electrode. Then, a voltage Vx of the X electrode is gradually increased due to the resonance. In addition, the capacitors C1 and C2 are concurrently discharged by the current paths 610 and 620.

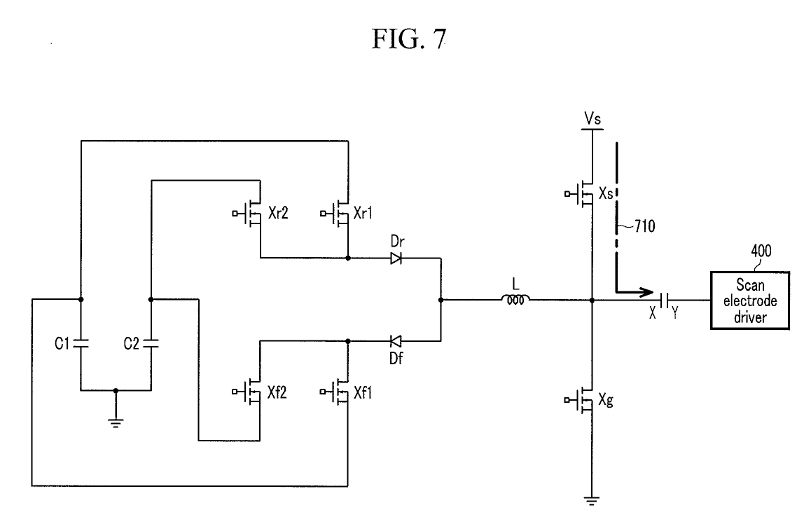

When the voltage Vx of the X electrode almost reaches the high level voltage Vs, the transistor Xs is turned on as shown in FIG. 5 so that a high level voltage maintaining period T2 is started. Then, the high level voltage Vs is applied to the X electrode through a current path 710 shown in FIG. 7 so that the voltage Vx of the X electrode is maintained at the high level voltage Vs. The transistors Xr1 and Xr2 are turned off at the starting point of or during the high level voltage maintaining period T2.

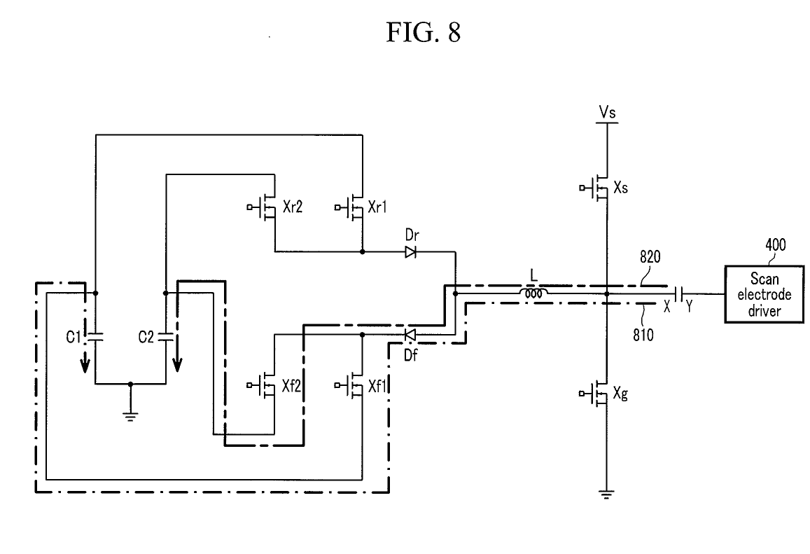

Subsequently, as shown in FIG. 5, a falling period T3 is started with the transistor Xs being turned off, and the transistors Xf1 and Xf2 being turned on. Accordingly, as shown in FIG. 8, a resonance is generated between the inductor L and the panel capacitor through a current path 810 that includes the X electrode, the inductor L, the diode Df, the transistor Xf1 and the capacitor C1, and a current path 820 that includes the X electrode, the inductor L, the diode Df, the transistor Xf2 and the capacitor C2. Accordingly, the voltage Vx of the X electrode is gradually decreased due to the resonance. In addition, the capacitors C1 and C2 are concurrently charged by the current paths 810 and 820.

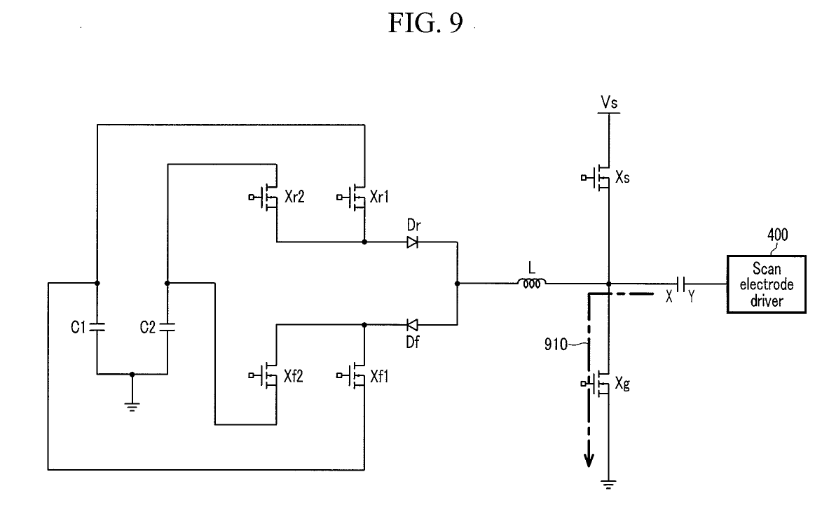

When the voltage Vx of the X electrode is decreased to a level close to the low level voltage, and as shown in FIG. 5, the transistor Xg is turned on so that a low level voltage maintaining period T4 is started. Then, the low level voltage is applied to the X electrode through a current path 910 shown in FIG. 9 so that the voltage Vx of the X electrode is maintained at the low level voltage. The transistors Xf1 and Xf2 are turned off at the starting point of or during the low level voltage maintaining period T4.

The high level voltage Vs and the low level voltage can be alternately applied to the X electrode by repeating the periods T1 to T4. In addition, the scan electrode driver 400 may apply the low level voltage to the Y electrode during the high level voltage maintaining period T2 and may apply the high level voltage Vs to the Y electrode during the low level voltage maintaining period T4.

When a deviation exists between capacitances of the two capacitors C1 and C2 or between parasitic inductance components respectively coupled to the two capacitors C1 and C2, a resonance cycle in the current path 610 may differ from a resonance cycle in the current path 620. The current supplied to the X electrode in the rising period T1 is a sum of the currents supplied by the two capacitors C1 and C2, and therefore a positive current may flow to the capacitor C1, and a negative current may flow to the capacitor C2 even though the current supplied to the X electrode at the finishing point of the rising period T1, i.e., the starting point of the high voltage maintain period T2, is substantially 0 A. However, since the transistors Xr1 and Xr2 are turned off in the high voltage maintaining period T2, a closed loop which includes the capacitor C1, the transistors Xr1 and Xr2, and the capacitor C2 is not formed, and no current can flow between the capacitors C1 and C2. Accordingly, a resonance does not occur due to a current flowing between the capacitors C1 and C2 in a closed loop that includes the capacitors C1 and C2. As a result, the temperature of the capacitors C1 and C2 can be prevented from being increased.

In addition, although a current may flow between the capacitors C1 and C2 at the finishing point of the falling period T3, i.e., the starting point of the low voltage maintaining period T4, a resonance does not occur with the capacitors C1 and C2 since the transistors Xf1 and Xf2 are turned off in the low voltage maintaining period T4, thereby disconnecting the connection between the capacitors C1 and C2.

In the sustain discharge circuit 510 of FIG. 4, the high level voltage is set to the Vs voltage, and the low level voltage is set to 0V in order to generate the sustain pulse of FIG. 2. However, in some embodiments of the present invention, the high level voltage may be set to the Vs voltage, and the low level voltage may be set to the -Vs voltage for generating the sustain pulses shown in FIG. 3.

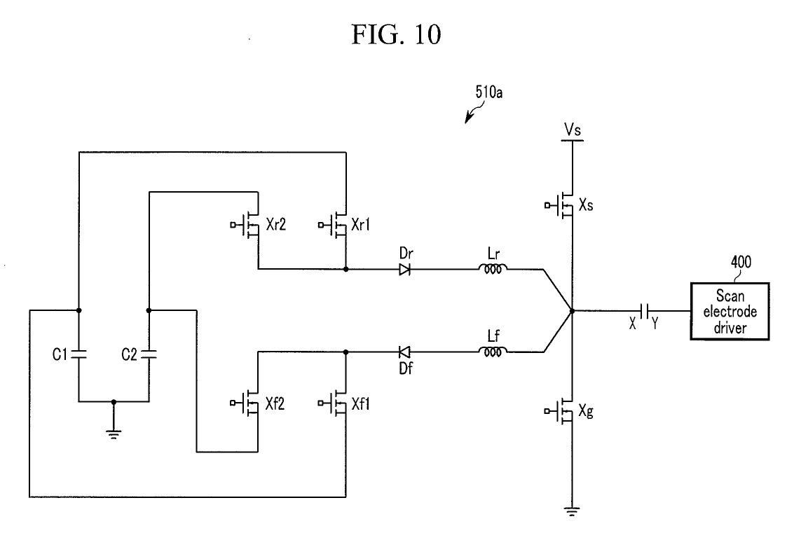

Sustain discharge circuits according to other exemplary embodiments of the present invention will be described with reference to FIG. 10 to FIG. 22.

FIG. 10 to FIG. 22 are schematic drawings respectively illustrating circuit diagrams of sustain discharge circuits according to other exemplary embodiments of the present invention.

Referring to FIG. 10, in a sustain discharge circuit 510a according to another exemplary embodiment of the present invention, the inductor L of the sustain discharge circuit 510 shown in FIG. 4 is replaced with a rising inductor Lr and a falling inductor Lf.

In FIG. 10, one terminal of the rising inductor Lr is coupled to the cathode of the diode Dr, one terminal of the falling inductor Lf is coupled to the anode of the diode Df, and the other terminal of each of the inductors Lr and Lf is coupled to the X electrode. Then, the resonance occurs between the rising inductor Lr and the panel capacitor in the rising period T1, and the resonance occurs between the falling inductor Lf and the panel capacitor in the falling period T2.

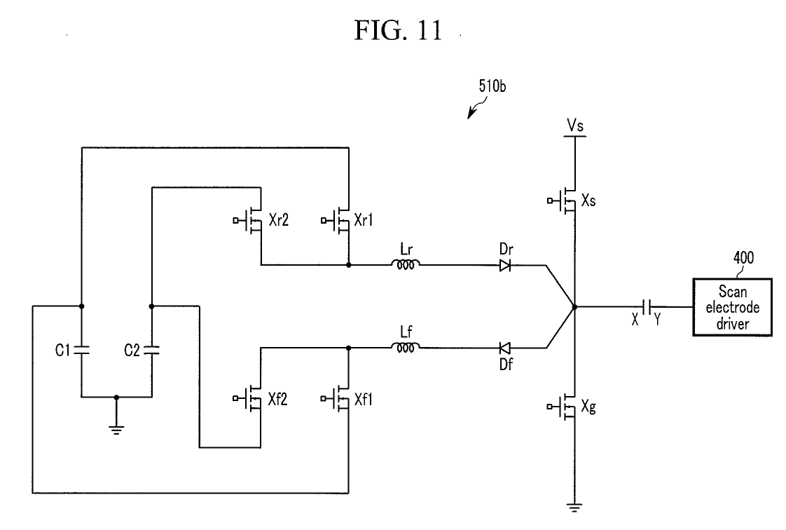

In FIG. 11, in a sustain discharge circuit 510b, a serial connection order of the diode Dr and the rising inductor Lr may be different from that of the sustain discharge circuit 510a (i.e., position switched), and a serial connection order of the diode Df and the falling inductor Lf may be different from that of the sustain discharge circuit 510a (i.e., position switched). In further detail, the cathode of the diode Dr is coupled to the X electrode. One terminal of the rising inductor Lr is coupled to the sources of the transistors Xr1 and Xr2, and the other terminal of the rising inductor Lr is coupled to the anode of the diode Dr. In addition, the anode of the diode Df is coupled to the X electrode. One terminal of the falling inductor Lf is coupled to the drains of the transistors Xf1 and Xf2, and the other terminal of the falling inductor Lf is coupled to the cathode of the diode Df.

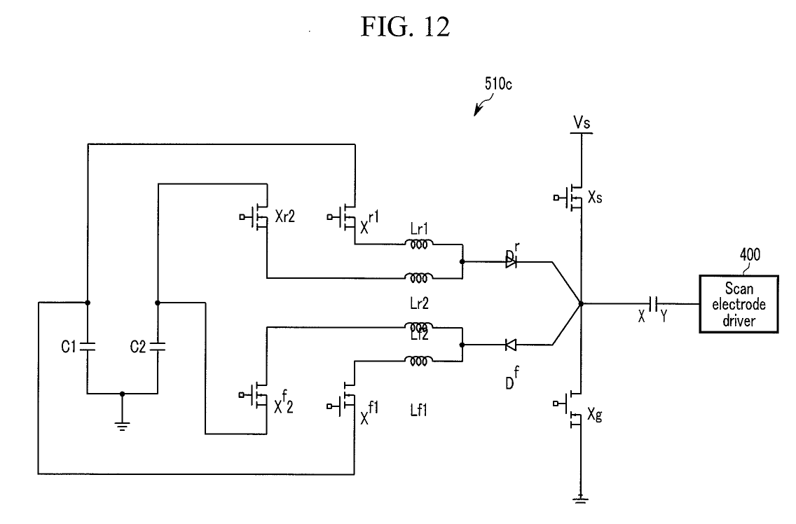

Referring to FIG. 12, in a sustain discharge circuit 510c according to yet another exemplary embodiment of the present invention, the rising inductor Lr and the falling inductor Lf of the sustain discharge circuit 510a shown in FIG. 10 may respectively be replaced with a plurality of rising inductors Lr1 and Lr2 and a plurality of falling inductors Lf1 and Lf2.

In detail, one terminal of the rising inductor Lr1 is coupled to the source of the transistor Xr1, one terminal of the rising inductor Lr2 is coupled to the source of the transistor Xr2, and the other terminal of each of the rising inductors Lr1 and Lr2 is coupled to the anode of the diode Dr. In addition, one terminal of the falling inductor Lf1 is coupled to the drain of the transistor Xf1, one terminal of the falling inductor Lf2 is coupled to the drain of the transistor Xf2, and the other terminal of each of the falling inductors Lf1 and Lf2 is coupled to the cathode of the diode Df.

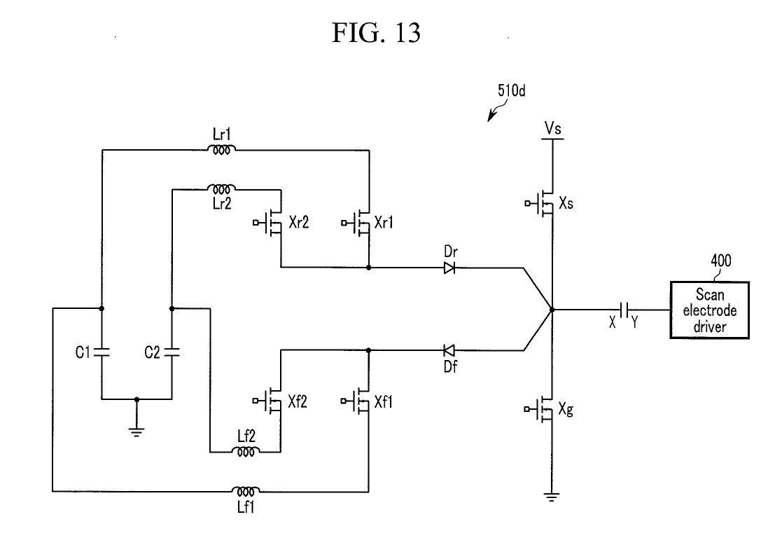

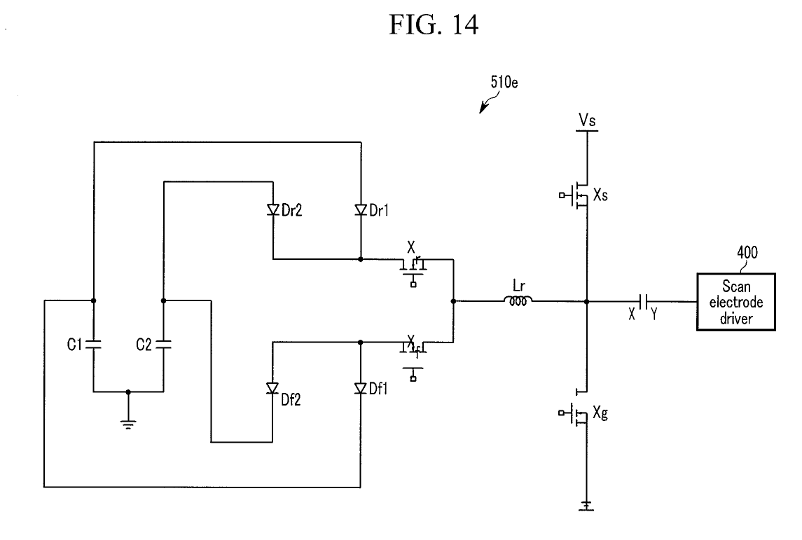

As shown in a sustain discharge circuit 510d of FIG. 13, a serial connection order of the transistors Xr1/Xr2 and the rising inductors Lr1/Lr2 may be different from that of the sustain discharge circuit 510c (i.e., position switched), and a serial connection order of the transistors Xf1/Xf2 and the falling inductors Lf1/Lf2 may be different from that of the sustain discharge circuit 510c (i.e., position switched). In further detail, one terminal of the rising inductor Lr1/Lr2 is coupled to the other terminal of the capacitor C1/C2, and the other terminal of the rising inductor Lr1/Lr2 is coupled to the drain of the transistor Xr1/Xr2. In addition, one terminal of the falling inductor Lf1/Lf2 is coupled to the other terminal of the capacitor C1/C2, and the other terminal of the falling inductor Lf1/Lf2 is coupled to the source of the transistor Xf1/Xf2.

Referring to FIG. 14, in a sustain discharge circuit 510e according to yet another exemplary embodiment of the present invention, the diode Dr may be replaced with a plurality of diodes Dr1 and Dr2, the diode Df may be replaced with a plurality of diodes Df1 and Df2, the transistors Xr1 and Xr2 may be replaced with a transistor Xr, and the transistors Xf1 and Xf2 may be replaced with a transistor Xf.

In further detail, cathodes of the diodes Dr1 and Dr2 are coupled to a drain of the transistor Xr, an anode of the diode Dr1 is coupled to the other terminal of the capacitor C1, and an anode of the diode Dr2 is coupled to the other terminal of the capacitor C2. Anodes of the diodes Df1 and Df2 are coupled to a source of the transistor Xf, a cathode of the diode Df1 is coupled to the other terminal of the capacitor C1, and a cathode of the diode Df2 is coupled to the other terminal of the capacitor C2. A source of the transistor Xr and a drain of the transistor Xf are coupled to one terminal of the inductor Lr, and the other terminal of the inductor Lr is coupled to the X electrode.

In the rising period T1, the transistor Xr is turned on so that a resonance is generated between the inductor L and the panel capacitor through a current path that includes the capacitor C1, the diode Dr1, the transistor Xr, the inductor L and the X electrode, and a current path that includes the capacitor C2, the diode Dr2, the transistor Xr, the inductor L, and the X electrode. Accordingly, the voltage Vx of the X electrode is gradually increased due to the resonance. In the falling period T3, the transistor Xf is turned on so that a resonance is generated between the inductor L and the panel capacitor through a current path that includes the X electrode, the inductor L, the transistor Xf, the diode Df1 and the capacitor C1, and a current path that includes the X electrode, the inductor L, the transistor Xf, the diode Df2 and the capacitor C2. Accordingly, the voltage Vx of the X electrode is gradually decreased due to the resonance.

In FIG. 14, since the cathode of the diode Dr1 is coupled to the cathode of the diode Dr2, a current path between the capacitors C1 and C2 is not formed by the diodes Dr1 and Dr2 in the high voltage maintaining period T2. In addition, since the anode of the diode Df1 is coupled to the anode of the diode Df2, a current path between the capacitors C1 and C2 is not formed by the diodes Df1 and Df2 in the low voltage maintaining period T4. Accordingly, a current does not flow between the capacitors C1 and C2 in the high voltage maintaining period T2 and the low voltage maintaining period T4. As a result, the temperatures of the capacitors C1 and C2 can be prevented from being increased.

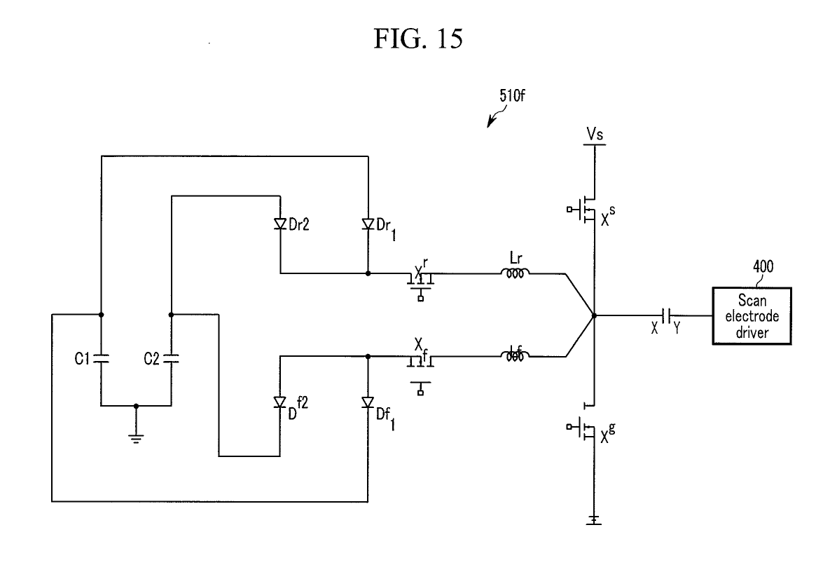

Referring to FIG. 15, in a sustain discharge circuit 510f according to yet another exemplary embodiment of the present invention, the inductor L of the sustain discharge circuit of FIG. 14 may be replaced with a rising inductor Lr and a failing inductor Lf. That is, one terminal of the rising inductor Lr is coupled to the source of the transistor Xr, one terminal of the falling inductor Lf is coupled to the drain of the transistor Xf, and the other terminal of each of the inductors Lr and Lf is coupled to the X electrode.

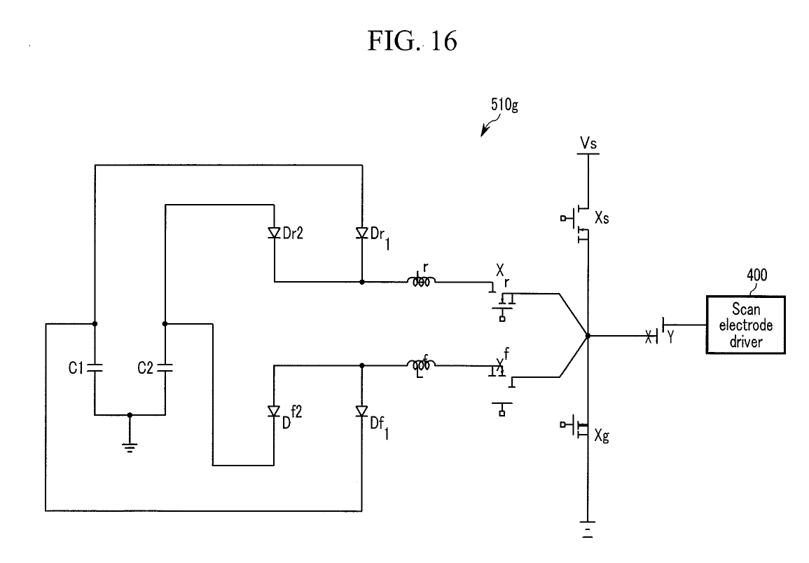

Referring to FIG. 16, a sustain discharge circuit 510g according to an embodiment of the present invention, the transistor Xr and the rising inductor Lr are connected serially to each other. Their serial connection order may be different from that of the sustain discharge circuit 510f (i.e., position switched), and a serial connection order of the transistor Xf and the falling inductor Lf may be different from that of the sustain discharge circuit 510f (i.e., position switched). That is, the source of the transistor Xr is coupled to the X electrode, and the other terminal of the rising inductor Lr having one terminal coupled to the cathodes of the diodes Dr1 and Dr2 is coupled to the drain of the transistor Xr. In addition, the drain of the transistor Xf is coupled to the X electrode, and the other terminal of the falling inductor Lf having one terminal coupled to the anodes of the diodes Df1 and Df2 is coupled to the source of the transistor Xf.

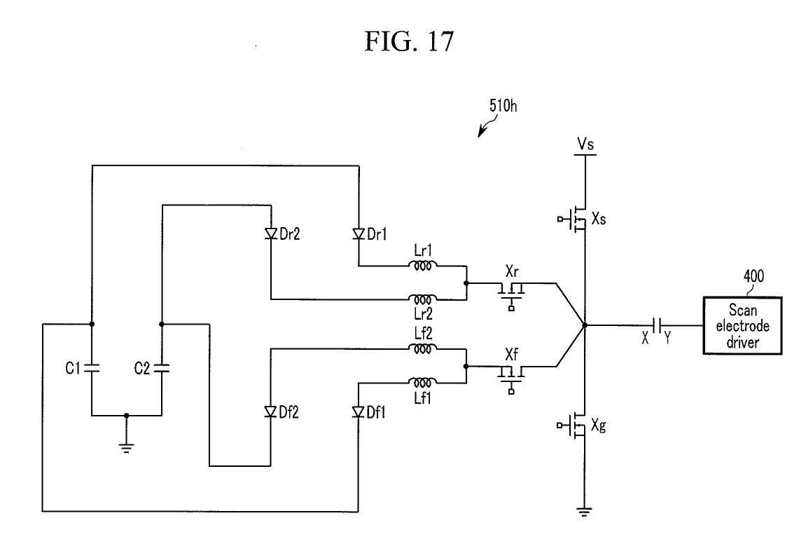

Referring FIG. 17, in a sustain discharge circuit 510h according to yet another exemplary embodiment of the present invention, the rising inductor Lr and the falling inductor Lf of the sustain discharge circuit 510g shown in FIG. 16 may be respectively replaced with a plurality of rising inductors Lr1 and Lr2 and a plurality of falling inductors Lf1 and Lf2.

In further detail, one terminal of the rising inductor Lr1 is coupled to the cathode of the diode Dr1, one terminal of the rising inductor Lr2 is coupled to the cathode of the diode Dr2, and the other terminal of each of the rising inductors Lr1 and Lr2 is coupled to the drain of the transistor Xr. In addition, one terminal of the falling inductor Lf1 is coupled to the anode of the diode Df1, one terminal of the falling inductor Lf2 is coupled to the anode of the diode Df2, and the other terminal of each of the falling inductors Lf1 and Lf2 is coupled to the source of the transistor Xf.

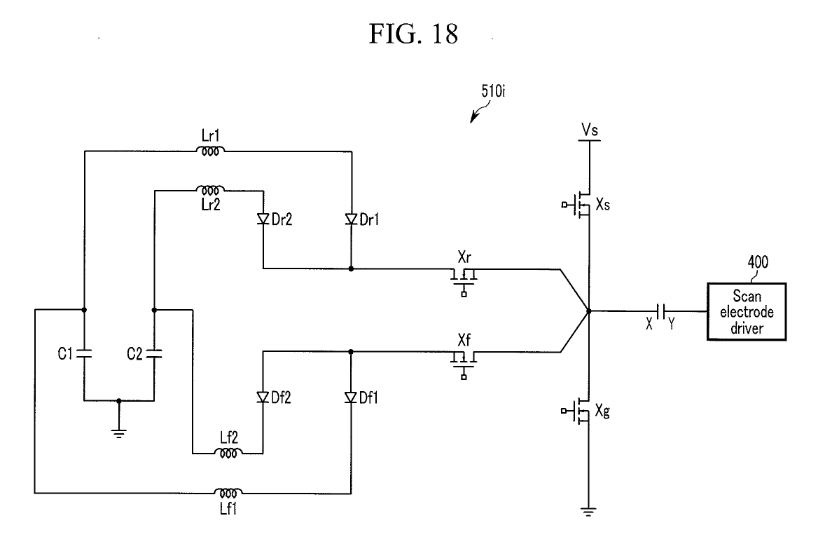

As shown in a sustain discharge circuit 510i of FIG. 18, a serial connection order of the diode Dr1/Dr2 and the rising inductor Lr1/Lr2 may be different from that of the sustain discharge circuit 510h (i.e., position switched), and a serial connection order of the diode Df1/Df2 and the falling inductor Lf1/Lf2 may be different from that of the sustain discharge circuit 510h (i.e., position switched). That is, one terminal of the rising inductor Lr1/Lr2 is coupled to the other terminal of the capacitor C1/C2, and the other terminal of the rising inductor Lr1/Lr2 is coupled to the anode of the diode Dr1/Dr2. In addition, one terminal of the falling inductor Lf1/Lf2 is coupled to the other terminal of the capacitor C1/C2, and the other terminal of the falling inductor Lf1/Lf2 is coupled to the cathode of the diode Df1/Df2.

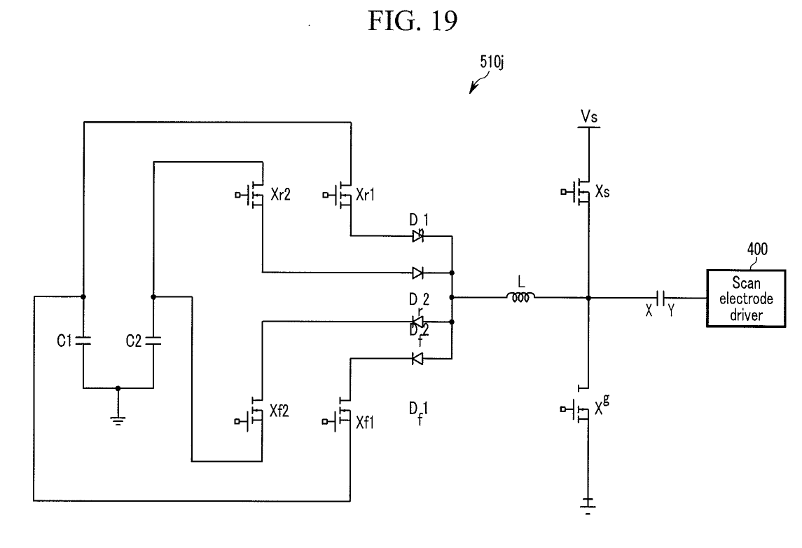

Referring to FIG. 19, in a sustain discharge circuit 510j according to yet another exemplary embodiment of the present invention, the diode Dr and the diode Df of the sustain discharge circuit 510 shown in FIG. 4 may be replaced with a plurality of diodes Dr1 and Dr2, and a plurality of diodes Df1 and Df2, respectively.

In further detail, an anode of the diode Dr1 is coupled to the source of the transistor Xr1, an anode of the diode Dr2 is coupled to the source of the transistor Xr2, and cathodes of the diodes Dr1 and Dr2 are coupled to one terminal of the inductor L. In addition, a cathode of the diode Df1 is coupled to the drain of the transistor Xf1, a cathode of the diode Df2 is coupled to the drain of the transistor Xf2, and anodes of the diodes Df1 and Df2 are coupled to the one terminal of the inductor L.

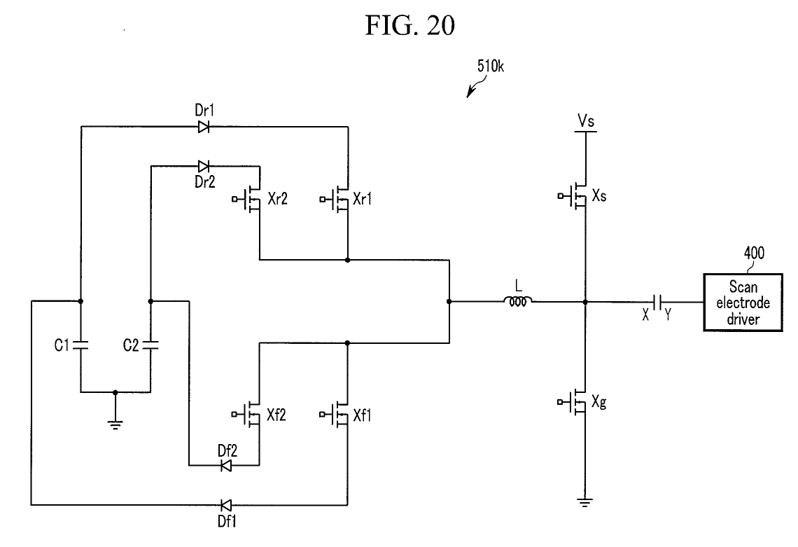

As shown in a sustain discharge circuit 510k of FIG. 20, a serial connection order of the diodes Dr1/Dr2 and the transistors Xr1/Xr2 may be different from that of the sustain discharge circuit 510j (i.e., position switched) of FIG. 19, and a serial connection order of the diodes Df1/Df2 and the transistors Xf1/Xf2 may be different from that of the sustain discharge circuit 510j (i.e., position switched). That is, the anode of the diode Dr1/Dr2 is coupled to the other terminal of the capacitor C1/C2, and the cathode of the diode Dr1/Dr2 is coupled to the drain of the transistor Xr1/Xr2. In addition, the cathode of the diode Df1/Df2 is coupled to the other terminal of the capacitor C1/C2, and the anode of the diode Df1/Df2 is coupled to the source of the transistor Xf1/Xf2.

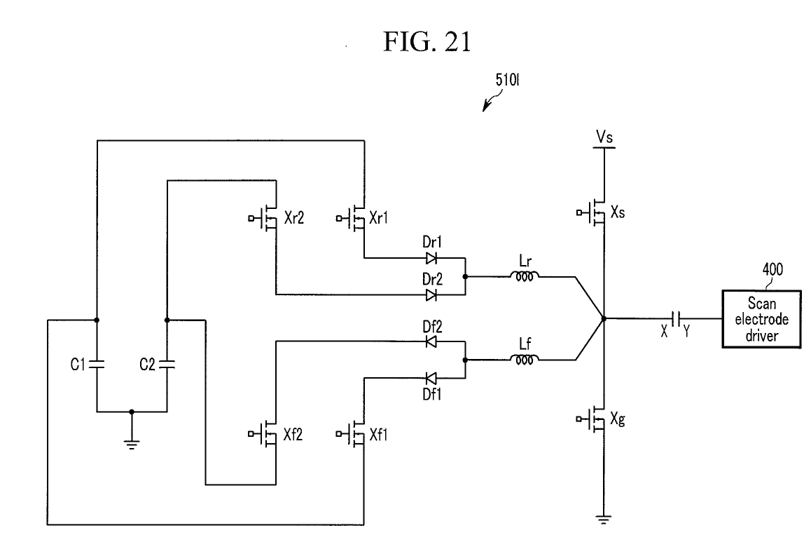

Referring to FIG. 21, in a sustain discharge circuit 5101 according to yet another exemplary embodiment of the present invention, the inductor L of the sustain discharge circuit 510j/510k shown in FIG. 19 or FIG. 20 may be replaced with a rising inductor Lr and a falling inductor Lf.

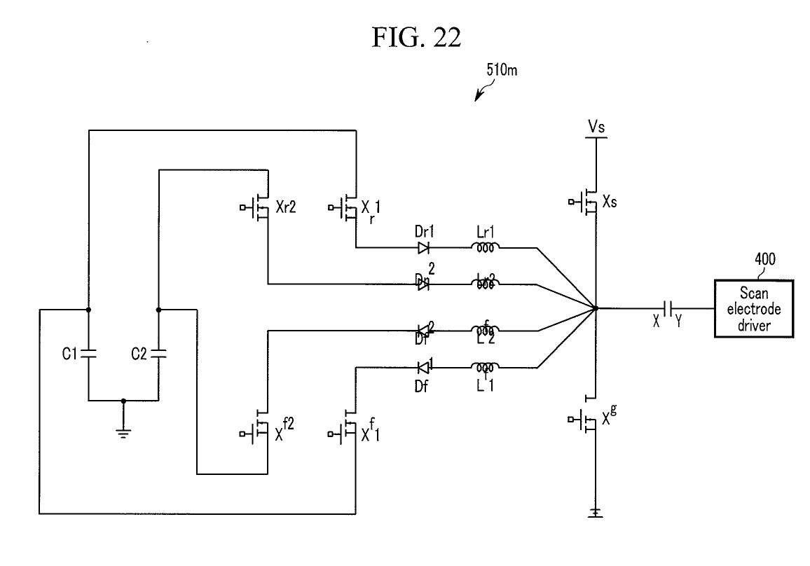

Referring to FIG. 22, in a sustain discharge circuit 510m according to yet another exemplary embodiment of the present invention, the rising inductor Lr and the falling inductor Lf of the sustain discharge circuit 5101 shown in FIG. 21 may be replaced with a plurality of rising inductors Lr1 and Lr2, and a plurality of falling inductors Lf1 and Lf2, respectively.

In further detail, one terminal of the rising inductor Lr1 is coupled to the cathode of the diode Dr1, one terminal of the rising inductor Lr2 is coupled to the cathode of the diode Dr2, and the other terminal of each of the rising inductors Lr1 and Lr2 is coupled to the X electrode. In addition, one terminal of the falling inductor Lf1 is coupled to the anode of the diode Df1, one terminal of the falling inductor Lf2 is coupled to the anode of the diode Df2, and the other terminal of each of the falling inductors Lf1 and Lf2 is coupled to the X electrode.

In FIG. 22, a serial connection order of the rising inductors Lr1/Lr2, the diodes Dr1/Dr2, and the transistors Xr1/Xr2 may be switched, and a serial connection order of the falling inductors Lf1/Lf2, the diodes Df1/Df2, and the transistors Xf1/Xf2 may be switched.

As described above, according to the exemplary embodiments of the present invention, a direct parallel connection between a plurality of capacitors forming an energy recovery capacitor can be prevented by using active elements such transistors and diodes to block the formation of a closed loop connection that includes the plurality of capacitors, and accordingly, a resonance current that can be generated due to a deviation between the plurality of capacitors can be prevented.

While a number of exemplary embodiments of the present invention have been described, it is to be understood that the present invention is not limited to the disclosed embodiments, but, on the contrary, is intended to cover various modifications and equivalent arrangements included within the spirit and scope of the appended claims and their equivalents.

What is claimed is:

1. A plasma display comprising:
a display electrode; and
an energy recovery circuit comprising an energy recovery capacitor and a circuit unit, the circuit unit configured to form a first path between the energy recovery capacitor and the display electrode to change a voltage at the display electrode in a sustain period,
wherein the energy recovery capacitor comprises a plurality of capacitors configured to be charged concurrently, and
the circuit unit is configured to selectively substantially prevent a current from flowing between two capacitors of the plurality of capacitors via a second path.

2. The plasma display of claim 1, wherein the circuit unit comprises:
a plurality of switches, each of the plurality of switches having a first terminal coupled to a corresponding one of the plurality of capacitors and a second terminal; and
an inductive unit coupled between the display electrode and the plurality of switches,
wherein the second path comprises the plurality of switches.

3. The plasma display of claim 2,
wherein the inductive unit comprises a plurality of inductors,
wherein each of the plurality of inductors has a first terminal coupled to the display electrode, and
a second terminal coupled to the second terminal of a corresponding one of the plurality of switches.

4. The plasma display of claim 2, wherein the plurality of switches are configured to be turned off for substantially preventing the current.

5. The plasma display of claim 1, wherein the circuit unit comprises:
a plurality of switches, each of the plurality of switches having a first terminal coupled to the display electrode and a second terminal; and
an inductive unit coupled between the second terminals of the plurality of switches and the plurality of capacitors,
wherein the second path comprises the inductive unit and the plurality of switches.

6. The plasma display of claim 5,
wherein the circuit unit further comprises a plurality of diodes coupled between the inductive unit and the plurality of switches,
wherein the inductive unit comprises a plurality of inductors each coupled between a corresponding one of the plurality of capacitors and a corresponding one of the plurality of diodes, and
wherein the second path further comprises the plurality of diodes.

7. The plasma display of claim 5, wherein the plurality of switches are configured to be turned off for substantially preventing the current.

8. The plasma display of claim 1, wherein the circuit unit comprises:
a plurality of diodes each having one terminal coupled to a corresponding one of the plurality of capacitors;
a switching unit having one terminal coupled to another terminal of each of the plurality of diodes; and
an inductive unit coupled between the display electrode and another terminal of the switching unit,
wherein the second path comprises the plurality of diodes.

9. The plasma display of claim 1, wherein the circuit unit comprises:
a plurality of diodes each having one terminal coupled to a corresponding one of the plurality of capacitors;
a plurality of switches each having one terminal coupled to another terminal of at least one diode of the plurality of diodes; and
an inductive unit coupled between the display electrode and the plurality of switches,
wherein the second path comprises the plurality of diodes and the plurality of switches.

10. The plasma display of claim 1, wherein the circuit unit comprises:
a plurality of diodes each having one terminal coupled to a corresponding one of the plurality of capacitors;
a plurality of switches each having one terminal coupled to the display electrode; and
an inductive unit coupled between another terminal of each of the plurality of diodes and another terminal of each of the plurality of switches,
wherein the second path comprises the inductive unit, the plurality of diodes and the plurality of switches.

11. A plasma display comprising:
a display electrode;
a plurality of capacitors configured to be charged concurrently, each of the capacitors having a first terminal coupled to a ground terminal and a second terminal;
first switches, each of the first switches having a first terminal coupled to the second terminal of a corresponding one of the capacitors and a second terminal;
second switches, each of the second switches having a first terminal coupled to the second terminal of a corresponding one of the capacitors and a second terminal; and
an inductive unit coupled between the display electrode and the second terminals of the first switches and the second switches,
wherein the first switches are configured to form a first path between the capacitors and the display electrode to increase a voltage at the display electrode, and
the second switches are configured to form a second path between the capacitors and the display electrode to decrease the voltage at the display electrode.

12. The plasma display of claim 11, wherein the first switches and the second switches are configured to selectively substantially prevent a current from flowing between two capacitors of the capacitors via a third path.

13. The plasma display of claim 12, wherein the first switches and the second switches are configured to be turned off for substantially preventing the current.

14. The plasma display of claim 11, wherein the inductive unit comprises:
a first inductor having a first terminal coupled to the display electrode and a second terminal coupled to the second terminal of at least one of the first switches; and
a second inductor have a first terminal coupled to the display electrode and a second terminal coupled to the second terminal of at least one of the second switches.

15. A plasma display comprising:
a display electrode;
a plurality of capacitors configured to be charged concurrently, each of the capacitors having a first terminal coupled to a ground terminal and a second terminal;
a first switching unit having a terminal coupled to the display electrode;
a second switching unit having a terminal coupled to the display electrode;
first inductors coupled between the plurality of capacitors and the first switching unit, each of the first inductors having a terminal coupled to the second terminal of a corresponding one of the plurality of capacitors; and
second inductors coupled between the plurality of capacitors and the second switching unit, each of the second inductors having a terminal coupled to the second terminal of a corresponding one of the plurality of capacitors,
wherein the first switching unit is configured to form a first path between the capacitors and the display electrode to increase a voltage at the display electrode,
the second switching unit is configured to form a second path between the capacitors and the display electrode to decrease the voltage at the display electrode, and
the first switching unit and the second switching unit are configured to selectively substantially prevent a current from flowing between two capacitors of the capacitors via a third path.

16. The plasma display of claim 15, further comprising first diodes and second diodes,
wherein each of the first diodes is coupled between a corresponding one of the first inductors and the first switching unit,
each of the second diodes is coupled between a corresponding one of the second inductors and the second switching unit, and
wherein the third path further comprises the first diodes or the second diodes.

17. The plasma display of claim 15, wherein the first switching unit and the second switching unit are configured to be turned off for substantially preventing the current.

18. A plasma display comprising:
a display electrode;
a plurality of capacitors, each of the capacitors having a first terminal coupled to a ground terminal and a second terminal;
a plurality of first diodes each having a first terminal coupled to the second terminal of a corresponding one of the plurality of capacitors and a second terminal;
a plurality of second diodes each having a first terminal coupled to the second terminal of a corresponding one of the plurality of capacitors and a second terminal;
a first switching unit coupled between the second terminals of the plurality of first diodes and the display electrode; and
a second switching unit coupled between the second terminals of the plurality of second diodes and the display electrode,
wherein the first switching unit is configured to form a first path between the capacitors and the display electrode to increase a voltage at the display electrode, and
the second switching unit is configured to form a second path between the capacitors and the display electrode to decrease the voltage at the display electrode.

19. The plasma display of claim 18,
wherein the first switching unit comprises a plurality of first switches, each of the plurality of first switches having a terminal coupled to the second terminal of a corresponding one of the plurality of first diodes, and
wherein the second switching unit comprises a plurality of second switches, each of the plurality of second switches having a terminal coupled to the second terminal of a corresponding one of the plurality of second diodes.

20. A plasma display comprising:
a display electrode; and
an energy recovery circuit comprising an energy recovery capacitor and a circuit unit, the circuit unit configured to form a first path between the energy recovery capacitor and the display electrode to change a voltage at the display electrode in a sustain period,
wherein the energy recovery capacitor comprises a plurality of capacitors configured to be charged concurrently, and
the circuit unit is configured to selectively substantially prevent charge sharing between two capacitors of the plurality of capacitors while the circuit unit interrupts the first path.
